(19) United States
(12) Patent Application Publication
(10) Pub. No.: US 2010/0205112 A1
(43) Pub. Date: Aug. 12, 2010

(54) QUALITATIVE RETIREMENT ADVICE AND MANAGEMENT SYSTEM AND METHOD FOR CREATING A RETIREMENT PLAN

(76) Inventors: Mark Reynolds, Fort Wayne, IN (US); Marcia Reynolds, Fort Wayne, IN (US)

Correspondence Address: BAKER & DANIELS LLP;111 E. WAYNE STREET, SUITE 800, FORT WAYNE, IN, 46802, US

(21) Appl. No.: 12/731,192

(22) Filed: Mar. 25, 2010

Related U.S. Application Data
(63) Continuation of application No. 11/746,109, filed on May 9, 2007.
(60) Provisional application No. 60/800,663, filed on May 16, 2006.

(51) Int. Cl. G06Q 40/00; G06F 3/048

(52) U.S. Cl. 705/36 R; 705/35; 715/760

(57) ABSTRACT

The present invention involves a system and method for generating customized retirement plans for a user. A user interaction module for obtains user information and includes software for asking a plurality of questions relating to the user. The questions include at least one question relating to quantitative information of the retirement funds of the user and at least one question relating to qualitative information about the user. The advice module correlates user quantitative information on retirement funds and user qualitative information to generate a customized retirement plan for the user.

### CROSS-REFERENCE TO RELATED APPLICATIONS

This application is a continuation of application Ser. No. 11/746,109, filed May 9, 2007, which application claims priority under 35 U.S.C. §119(e) of U.S. Patent Provisional Application Ser. No. 60/800,663, filed May 16, 2006, the disclosure of which is explicitly incorporated by reference.

### BACKGROUND OF THE INVENTION

1. Field of the Invention

The invention relates to financial software. More specifically, the field of the invention is that of financial planning software for retirement planning.

2. Description of the Related Art

A large segment of the population is currently retired or approaching retirement without the benefits of having prepared for this phase of their lives. The trend in recent years away from traditional defined benefit plans (DB Plans) to defined contribution plans (DC Plans) leaves many with inadequate savings and little education about the issues related to managing the income that must be thoughtfully distributed from these assets. DC Plans do not generally provide for an income stream and many people have held multiple jobs over the course of their careers which results in funds being held in multiple forms and locations, further complicating the job of understanding and managing the distribution process. In addition, for reasons related to mistrust or uncertainty, fed by media coverage of recent corporate pension plan problems, ongoing concern about Social Security and healthcare costs, the majority of participants in traditional DB Plans are now taking their benefits in a lump sum.

The cost of obtaining personal financial advice is relatively high for those with assets in the lower wealth tiers. That cost is partly driven by the complexity of products and systems used by financial advisors which are designed primarily for clients in the more affluent and higher net worth wealth tiers. In addition, the years of professional training and level of expertise achieved by financial advisors makes their time and advice costly. Clients with significant assets and income sources find the services of a financial advisor critical. However, most of the population does not have the ability to afford those services and frankly, many advisors are not able to spend the time it takes to educate and plan for retirement for those without adequate assets to be able to fairly compensate the professional advisor.

The web-based financial planning tools currently available today are heavily biased toward quantitative issues alone. In most cases, the tools assume a fairly high level of sophistication and experience and do not address the qualitative issues that deal with life choices and desires that are critical to understanding and optimizing the lifestyle that can be supported by available assets and income. There are also a growing number of books and periodicals available on many related topics that are meant to inform and even overwhelm an individual trying to understand and manage the issues related to their retirement. Unfortunately, there is nothing available that manages to filter and customize all of this information into a comprehensive plan.

### SUMMARY OF THE INVENTION

The invention is a computerized system which allows individual users, through an interactive process using the internet, to acquire knowledge, aggregate predictive information related to quantitative data and qualitative information into a personalized database model, and to use that information to create a personal and customized plan for managing their retirement. The system of the present invention uses a series of proprietary rules and correlated index models to provide advice about expenses and income and to illustrate and offer potential solutions for investing accumulated savings and managing the distribution of those savings over the user's retirement horizon. The system of the present invention also creates advice scenarios within the context of educational support and lifestyle choices appropriate to create a comfortable and informed consumer.

The present invention relates to the methods and systems for collecting and analyzing quantitative and qualitative information about individual users in order to provide a comprehensive retirement plan. The invention is designed to serve the mass market, or lower wealth tiers, and provides predictive information about their financial situations, offers product and investment solutions based on qualitative inputs, and helps individual to manage their life choices and the plan on an ongoing basis.

The present invention, in one form, relates to a server for generating customized retirement plans for a user. The server has a user interaction module for obtaining user information, with software for asking a plurality of questions relating to the user. The questions include at least one question relating to quantitative information of the retirement funds of the user and at least one question relating to qualitative information about the user. This information is used by an advice module for correlating user quantitative information on retirement funds and user qualitative information to generate a customized retirement plan for the user.

Another aspect of the invention relates to a machine-readable program storage device for storing encoded instructions for a method of qualitative retirement planning according to the foregoing method.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIGS. 1 through 9 are screen shot diagrams of the operation of the present invention.

FIG. 10 is a schematic diagrammatic view of the system of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF AN EMBODIMENT OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

The detailed descriptions which follow are presented in part in terms of algorithms and symbolic representations of operations on data bits within a computer memory representing alphanumeric characters or other information. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical signals.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct more specialized apparatus to perform the required method steps. The required structure for a variety of these machines will appear from the description below.

The present invention deals with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects. Objects may also be invoked recursively, allowing for multiple applications of an objects methods until a condition is satisfied. Such recursive techniques may be the most efficient way to programmatically achieve a desired result.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment.

The terms “desktop”, “personal desktop facility”, and “PDF” mean a specific user interface which presents a menu or display of objects with associated settings for the user associated with the desktop, personal desktop facility, or PDF. When the PDF accesses a network resource, which typically requires an application program to execute on the remote server, the PDF calls an Application Program Interface, or “API”, to allow the user to provide commands to the network resource and observe any output. The term “Browser” refers to a program which is not necessarily apparent to the user, but which is responsible for transmitting messages between the PDF and the network server and for displaying and interacting with the network user. Browsers are designed to utilize a communications protocol for transmission of text and graphic information over a world wide network of computers, namely the “World Wide Web” or simply the “Web”. Examples of Browsers compatible with the present invention include the Navigator program sold by Netscape Corporation and the Internet Explorer sold by Microsoft Corporation (Navigator and Internet Explorer are trademarks of their respective owners). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

The terms “personal digital assistant” or “PDA”, as defined above, means any handheld, mobile device that combines computing, telephone, fax, e-mail and networking features. The terms “wireless wide area network” or “WWAN” mean a wireless network that serves as the medium for the transmission of data between a handheld device and a computer. The term “synchronization” means the exchanging of information between a handheld device and a desktop computer either via wires or wirelessly. Synchronization ensures that the data on both the handheld device and the desktop computer are identical.

In wireless wide area networks, communication primarily occurs through the transmission of radio signals over analog, digital cellular, or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), personal digital cellular (“PDC”), or through packet-data technology over analog systems such as cellular digital packet data (CDPD″) used on the Advance Mobile Phone Service (“AMPS”). The terms “wireless application protocol” or “WAP” mean a universal specification to facilitate the delivery and presentation of web-based data on handheld and mobile devices with small user interfaces.

The embodiment of the invention is presented to the user in individual self-directed stages or levels. At the first stage, the user may input and obtain information on a generic basis without providing any specific personal identification. This first stage provides the user with an introduction to the issues and begins the learning process by providing education and description of terms and concepts.

Also at this stage, the system allows the user to save the inputs and illustrations created in the process by creating a username and password. This creates a profile stored in computer memory and allows the user to pause and return to the process. This feature allows the user to collect more information, think about issues and answers provided, and to supplement or correct information already entered. The first stage makes some generic recommendations and provides descriptive illustrations as well as recommends some next steps.

Systems configured according to the present invention may incorporate quantitative analysis tools for retirement savings and planning that are generally known. One such system is disclosed in U.S. patent application Ser. No. 10/210,827, Publication Number 2003/0028466 A1, entitled “SYSTEM AND METHOD FOR PROVIDING FINANCIAL PLANNING AND ADVICE,” the disclosure of which is expressly incorporated by reference. Alternatively, systems configured according to the present invention may operate independently of such quantitative systems, and utilize such quantitative analysis using user data acquired according to the present invention. Thus, in the following detailed description, the actual implementation of an exemplary system may have the quantitative analysis tools either incorporated in the exemplary system or merely accessed by the exemplary system.

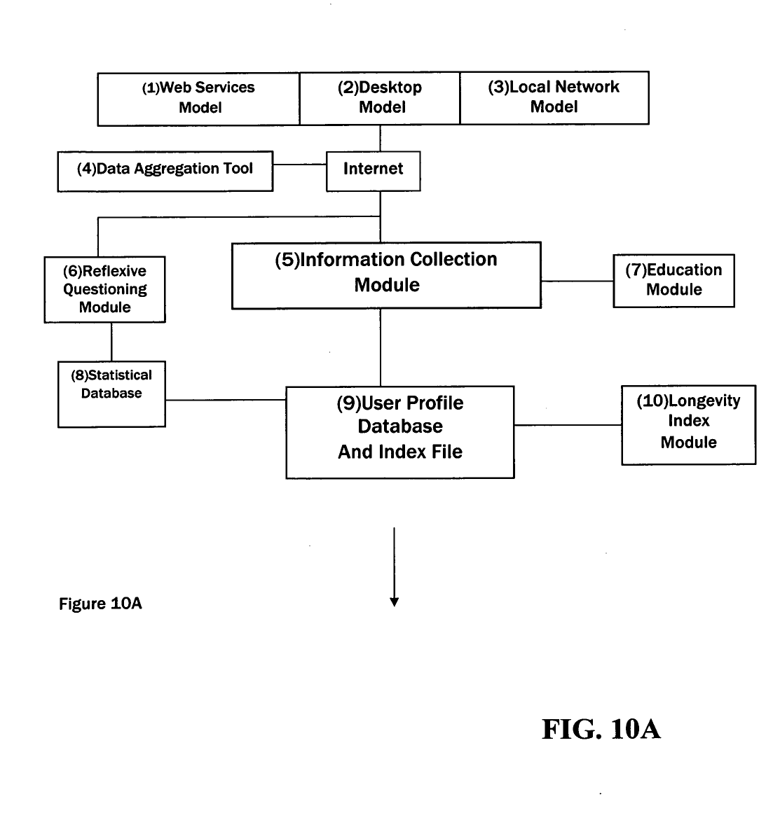

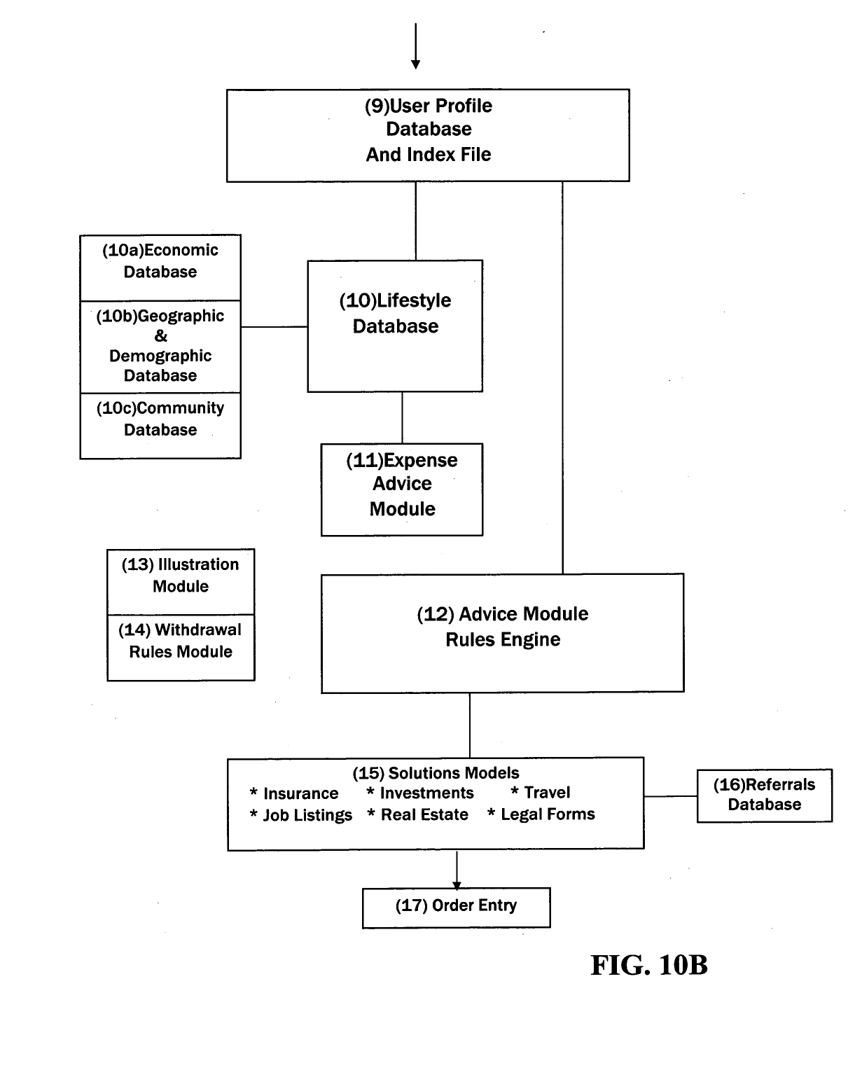

As shown in FIG. 10, an embodiment of the present invention has at the front end web-enabled or browser based Information Collection Module (5) that uses a reflexive questioning methodology to develop User Profile Database (9). User Profile Database (9) may have a plurality of predefined fields for the various numerical and qualitative information relating to a particular user or data subject (as it is possible that the actual user may be entering data for another person who is the data subject, but for simplicity in the following description the data subject shall be referred to as the “user”). Such a database may be a single file with such predefined fields, or may be an XML definition that may be physically stored in a plurality of different formats in different locations. Regardless of its specific embodiment, the database generally captures and maintains predictive information about each user including age, marital status, residence, work status, work plans, target retirement timeframes, interests and hobbies, lifestyle plans, health information, and financial status, etc. The system then uses both quantitative and qualitative information collected from individuals and with a programmatic process provides a comprehensive view of the choices available to customize an optimal individual retirement program.

The User Profile is populated by the user through Information Collection Module (5). While the exemplary embodiment is described as a web or browser based interactive module, Information Collection Module (5) may be a stand alone computer program, a remote computer, pda, or wireless device based information entry program which is later synchronized with User Profile Database (9). Each element may have multiple segments. The segments may include the follow items of information, or Profile Elements: (1) Gender, (2) Age, (3) Health, (4) Marital Status, (5) Education Level, (6) Computer Usage, (7) Residence, (8) Employment Status, (9) Employment History, (10) Employment Plans, (11) Family, (12) Family Locations, (13) Climate Preferences, (14) Hobbies/Interests/Pets, (15) Investment Experience, (16) Risk Tolerance, (17) Insurance Coverage, (18) Financial Data/Asset Inventory, (19) Expense Data, (20) Skills Inventory, (21) Living Arrangements (Current), and (22) Living Arrangements (Planned).

There are several ways to access Information Collection Module (5), most conveniently through the Internet. Web Services (1) model allows the User to access the system by remote access to the host server. With this model the programs and databases are maintained at the host site and not on the User's computer. Desktop (2) model allows the User to receive a copy of the Retirement Manager on machine readable media such as a CD. The User is then able to work off line and download packets of information at a later time. This method allows for lower line usage and more robust content. The third access method accesses the Retirement Manager via Local Area Network (3) such as an employer's site. The actual physical location of the various modules and databases utilized in the embodiments of the invention are not particularly important for the operation of the invention, these variations in embodiments of the invention are not limitations upon its deployment and use.

Education Module (7) is designed to provide the user with clear and understandable information about topics specifically related to their situation and User Profile information. The content of Education Module (7) covers topics such as inflation, diversification, insurance terms, and all other topics related to retirement. Although primarily available based on queries by the user, certain elements related to determining knowledge, suitability of products, risk tolerance and other issues fundamental to a sound retirement plan are an active part of collecting information and creating the User Profile by directing secondary questions on the basis of answers to primary questions (for example, if an individual lives far from an ocean yet indicates plans for ocean sailing, follow up questions may include whether a second home is contemplated or how often the individual plans on sailing—all of which effect expense planning). The system of the present invention also provides the user with information gathering checklists that serve to educate the user and provide, in question and answer form, information that the user can bring to a spouse or Human Resources staff at an employer to gather and understand the issues at hand and to collect the appropriate information. Such education and checklists may include, for example, minimum and maximum withdrawal limits for particular retirement accounts where an individual may be provided some general information and possibilities by Education Module (7) which is used to question a company retirement account manager to flesh out the individual's options.

Education Module (7) contains material to help the user understand the issues that are covered anywhere in the process of using the Retirement Manager. This module includes definitions and discussion of various retirement financial planning terms. Terms found within the Retirement Manager are linked to the Education Module so that the user can instantly refer to the definition which is followed by more in depth discussion and illustration where appropriate. Sample Topics include: Inflation, Diversification, Investments, Risk, Volatility, Longevity, Mutual Funds, Asset Allocation, Lifestyle Funds, Qualified & Non-Qualified Plans, Money Market Funds, Insurance Products, Equities, Life, Fixed Income Securities, Long Term Care, Exchange Traded Funds, Annuities, Real Estate, Health Coverage, Home Equity, Government Programs, Senior Living Communities, Medicare, Medicaid, and Prescription Drug Programs.

The process of reflexive questioning enabled by Reflexive Questioning Module (6) allows the system to mass customize not only the process, but proposed solutions and advice. In this way a series of “IF>THEN” commands, or other implementations of rule based commands, within the computer program drives the process to ask the user different subsequent questions based on answers to previous questions provided by the user. For example, if the user states that they are married, the Reflexive Questioning Module (6) creates a second profile which is added to the database with reference to the user. The system will correlate the answers provided by the first and second users in order to provide appropriate guidance for issues such as Social Security, joint versus individual insurance contracts, additional healthcare and lifestyle correlations, etc.

The system further contains aggregated user information in Statistical Database (8) which accumulates data and information input by all users in order to create internal Predictive Guidance Methodology which provides future users with higher probability guidance and outcomes. Statistical Database (8) may be continuously updated during the operation of the system, and may be enhanced by application of heuristic rules or knowledge management techniques, so that noted statistical trends are incorporated into planning for appropriate users.

The system further utilizes Longevity Index Module (10). Although not designed to prognosticate life expectancy, an individualized plan would not be complete without incorporating life expectancy discussion and education as well as building an income plan for the appropriate time horizon. In order to develop the proper scenarios, the systrem of the invention analyzes user input contained in the User Profile to provide projections for individual or individual and spouse reflecting scenarios for various longevity probabilities. Longevity Index is built based on standard actuarial tables provided by The Society of Actuaries correlated with User Profile information related to health, marital status, and other longevity related data. The system of the present invention uses the Longevity Index along with other User Profile data such as risk tolerance and Projected Expense Gap to advise suitable solutions. For example, an individual user with a high Longevity Index (long life expectancy) and moderate risk tolerance are advised toward more equity-based investment products as a hedge against inflation and lower purchasing power in later years.

A further aspect of the system of the present invention involves Expense Advice Module (11). This module references the user's profile, along with a database of economic, geographic, and demographic information to provide an individualized expense projection. The system of the present invention includes a programmatically designed and programmed database along with publicly available cost of living, tax, healthcare and other regionally indexed cost variables which are correlated and indexed to create “Projected Expenses” levels, adjusted for inflation, over the retirement horizon.

On the income side, the system aggregates revenues from all sources, based on information provided by the user and using financial models programmed into the system, with support from third party commercially available financial modeling software, including social security, pension plans, savings, continued income from work, along with all other sources identified. The system then uses known financial models to then project “Available Income” over the retirement horizon and to illustrate the potential volatility of results based on various financial products and economic conditions. Using the Available Income projection and correlating to the Projected Expenses scenarios the system then identifies any potential shortfall or surplus over the retirement horizon (Expense Gap Projection). Optionally, the User may ultimately decide to use the Retirement Manager to monitor the plan by providing financial institution account numbers which will allow the system to retrieve balances on a regular basis using commercially available aggregation tools (4).

A further feature of the system of the present invention involves a rules engine that is called the “Advice Module” (12). Advice Module (12) compiles all of the information accumulated and indexed to this point and correlates and uses internal rules programmed into tables or other procedures contained in the module to provide suggested solutions and courses of action for the user's review. It is anticipated that a large number of users in this target demographic will find a shortfall between “Projected Expenses” and “Available Income”. The system uses the User Profile and the Lifestyle Database (18) to propose changes in spending levels and will provide alternatives which could include changes in living arrangements to lower cost housing and/or lower cost communities within the user's desired geography. The system may also use the User Profile and Expense Gap Projection results to potentially find sources of income not currently monetized such as home equity. For example, the system educates, guides and assists with Reverse Mortgages when appropriate. In the lower wealth tiers, U.S. Census data indicates that 50% of available wealth is held in value in primary residence. In addition to educating and providing financial scenarios, the system contains or accesses database files which guides the user based on User Profile and further provides live links via the Internet to commercial real estate sites with actual listings and market data.

Advice Module (12) uses User Profile and Index File elements in order to create solution advice. In addition, the system considers the Expense Gap Projection when correlating to the Profile Elements to build the advice solutions. Each component will Profile Elements (PE's) from the as in these examples: to measure Investment knowledge and sophistication (5, 6, 8, 10, 15, 16, 17, 18, 19, 21); to measure risk tolerance (2, 4, 10, 11, 15, 16, 17, 18, 19, 20, 21); to advise upon living arrangements (2, 3, 4, 5, 7, 8, 10, 11, 12, 13, 14, 18, 19, 20, 22); to provide job opportunity advice (1, 3, 4, 6, 7, 9, 10, 11, 14, 15, 18, 19, 20, 21, 22); and to propose product solutions (2, 3, 4, 9, 16, 17, 18, 19, 20).

Another aspect of the invention involves Withdrawal Rules Module (14). When considering a portfolio of financial instruments and income sources the user must follow IRS regulations to meet minimum withdrawal limits from qualified plan money. Also a part of this function is to optimize the timing for application for Social Security benefits. The rules engine that addresses these issues is the Withdrawal rules Module which analyzes the financial elements within the User Profile to provide advice to meet regulatory requirements and minimize tax impact of withdrawals.

For many users, a phased transition to full retirement will be either desired or necessary. The system is configured to present Solution Module (15) to the user which measures financial and emotional readiness for retirement. This module asks for some general financial information, calculates expected Social Security income, presents some expense information, and, based on their user profile or presented generically, challenges their preparedness for change in life situation. Subsequently, for those who need or desire to continue working, and based on the User Profile and Expense Gap Projection, the system will direct the user to a database containing names and descriptions of employers that have indicated an interest in, and have been recognized as having an affinity for hiring part time senior workers in Referrals Database (16). These employers could be from the private or public sectors and could also include non-profit or similar volunteer opportunities. The system matches users with opportunities based on needs and User Profile data. After initial screening, the system then links the user with the potential employer site or other means of communicating. In addition to internal database selections, the system may send the appropriate criteria to commercial job search sites such as Monster.Com in Order Entry (17).

In addition to filtering and providing advice to enhance and optimize the users financial projections and retirement affordability, the system through Order Entry (17) may link the users to information, shopping and participation sites to support travel, hobby, education, healthcare and other interests in order to provide a comprehensive view of the opportunities using Economic Database (18a), Geographic & Demographic Database (18b), and Community Database (18c) and to filter those opportunities to meet the confines of the financial plan.

Most financial planning software available today provides a static, point-in-time view of the financial position of a user. Since most individuals' lives continue to change in myriad ways, the plan may become materially obsolete soon after completion. The system provides the user with the ability to maintain the retirement plan by continuing to provide current information and updating the User Profile. Although the system provides for continuous update by registered users, the ideal functionality provided within the system maintains the personal account and provider information necessary to enable regular update of financial information via commonly available “screen scraping” software which enables the collection of financial data electronically. By maintaining a comprehensive User Profile including account numbers from participating financial institutions, the system may update the plan on a regular basis and identify material variances for planned income and expense. This allows monitoring and reporting of financial activity for fraudulent as well as unintended transactions.

The system is designed as a self-contained and comprehensive planning tool for the lower wealth tier individuals who are currently under served or unserved. Although the system calls upon links with other available information sources and uses commercial tools where available, the professional education provided, advice given, and packaged solutions offered by the system is modular in nature so that another advisor utilize the tool to help them to more efficiently serve their lower wealth tier clients and substitute their own modules containing their own specific advice and solutions.

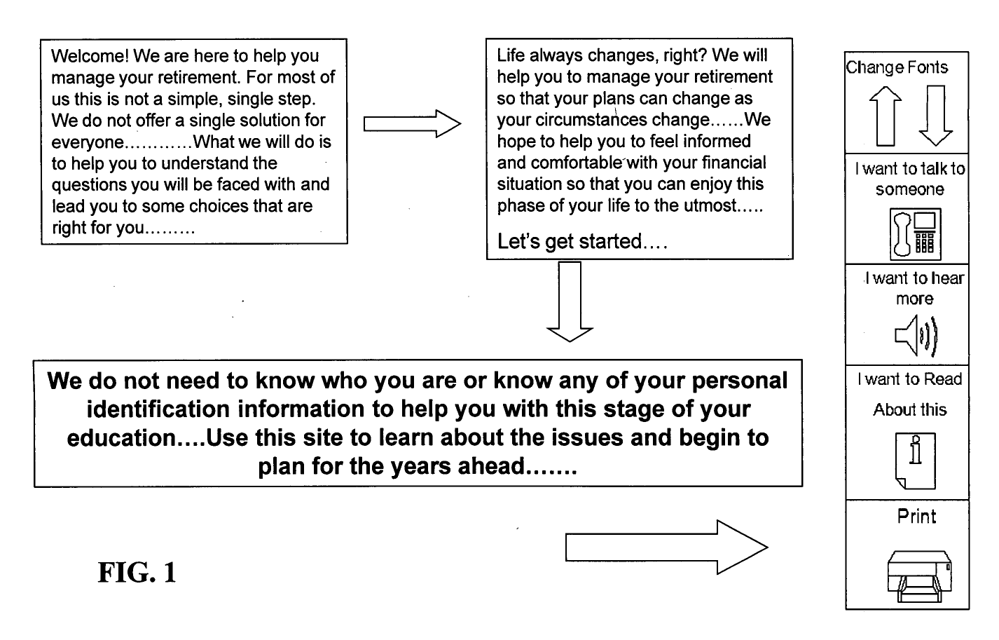

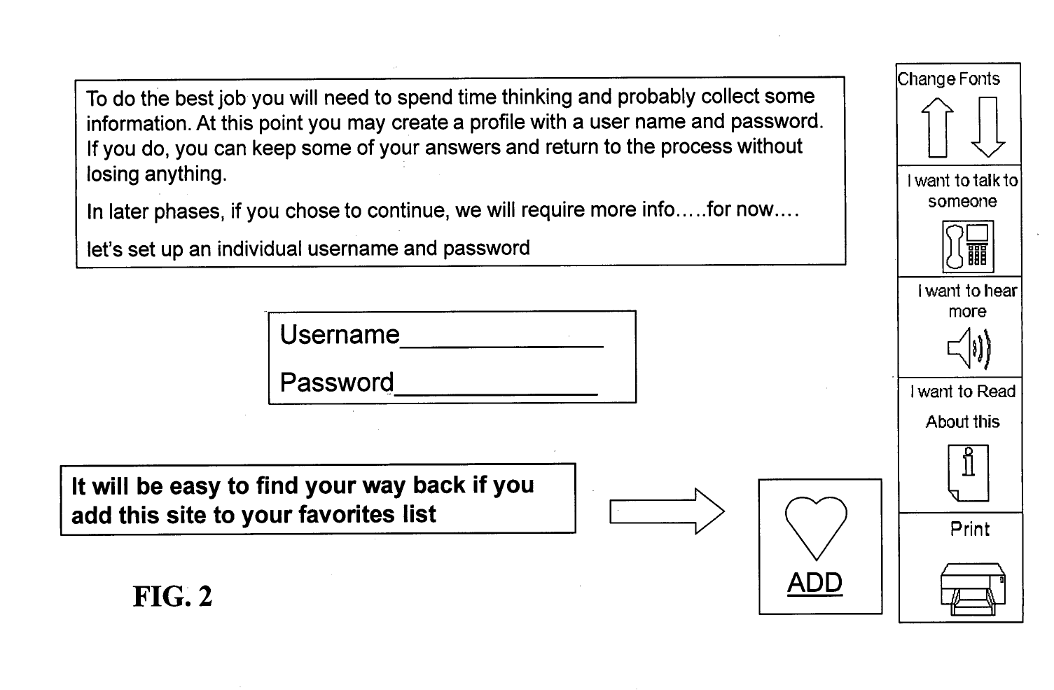

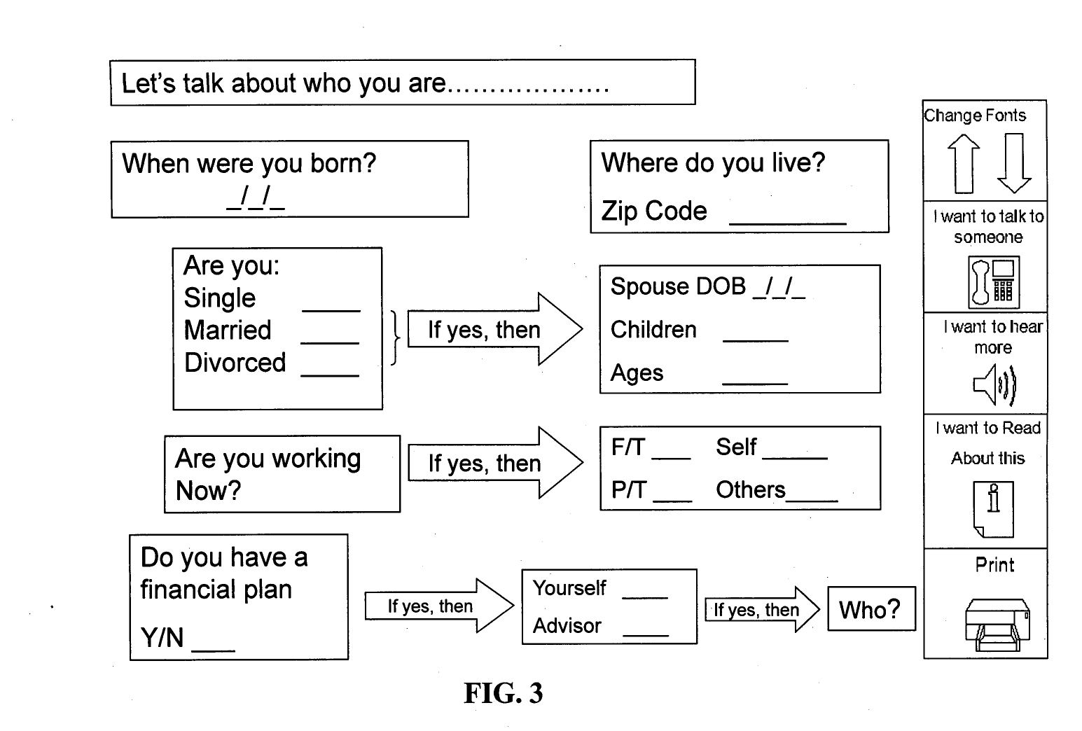

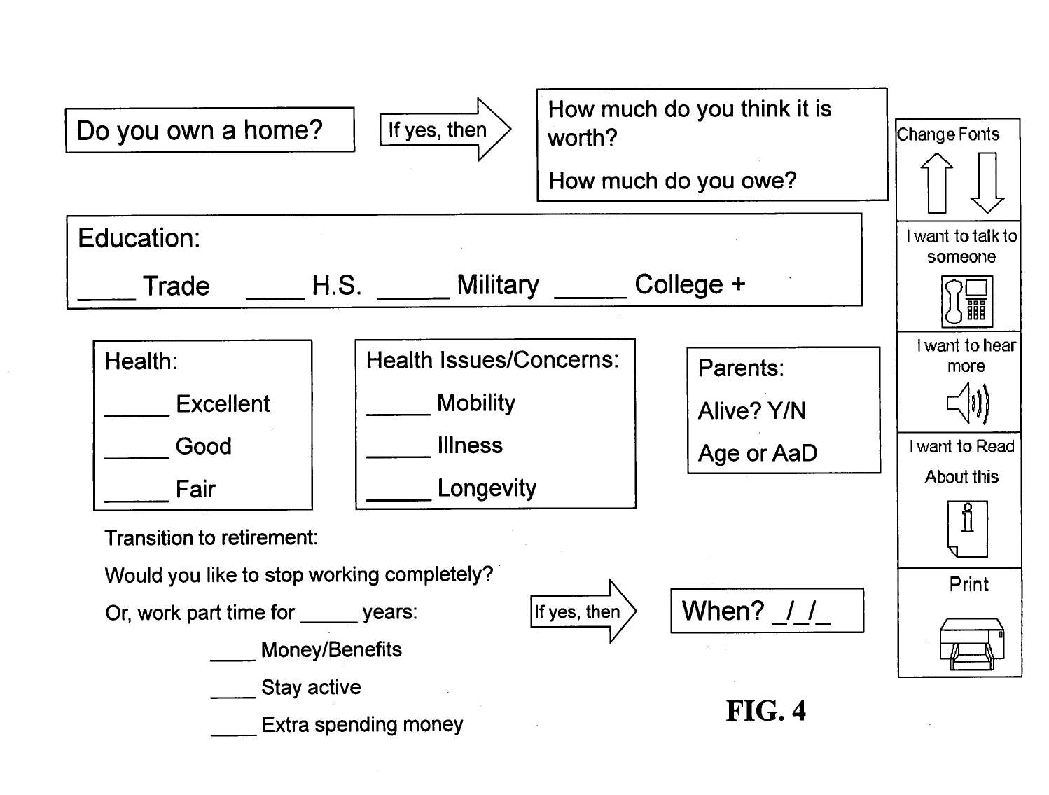

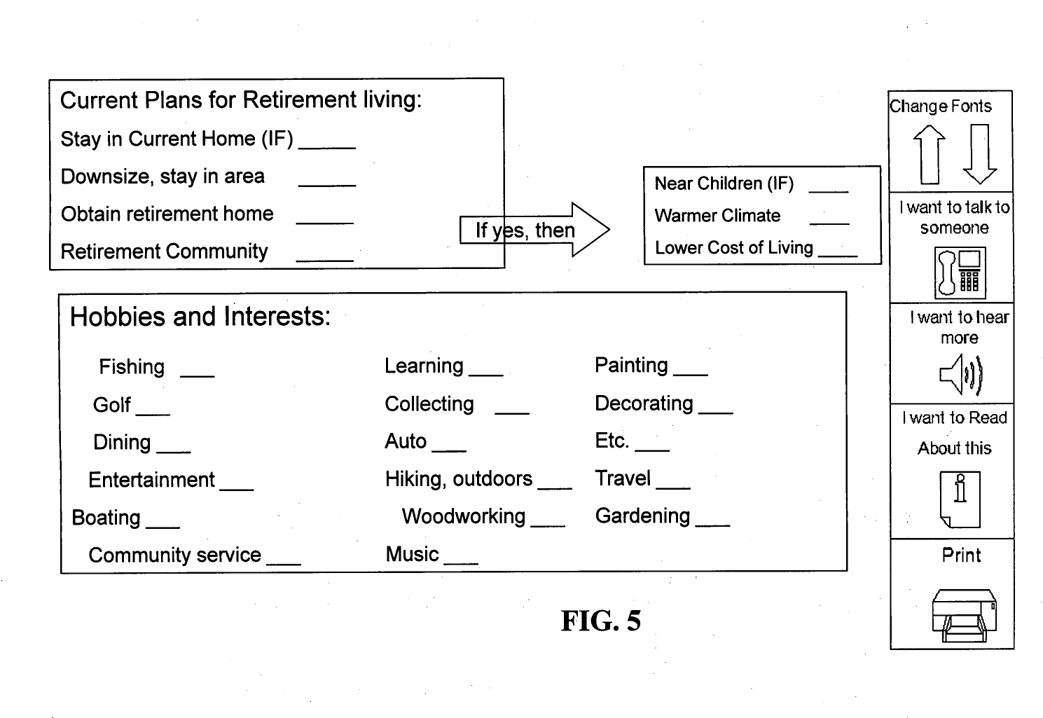

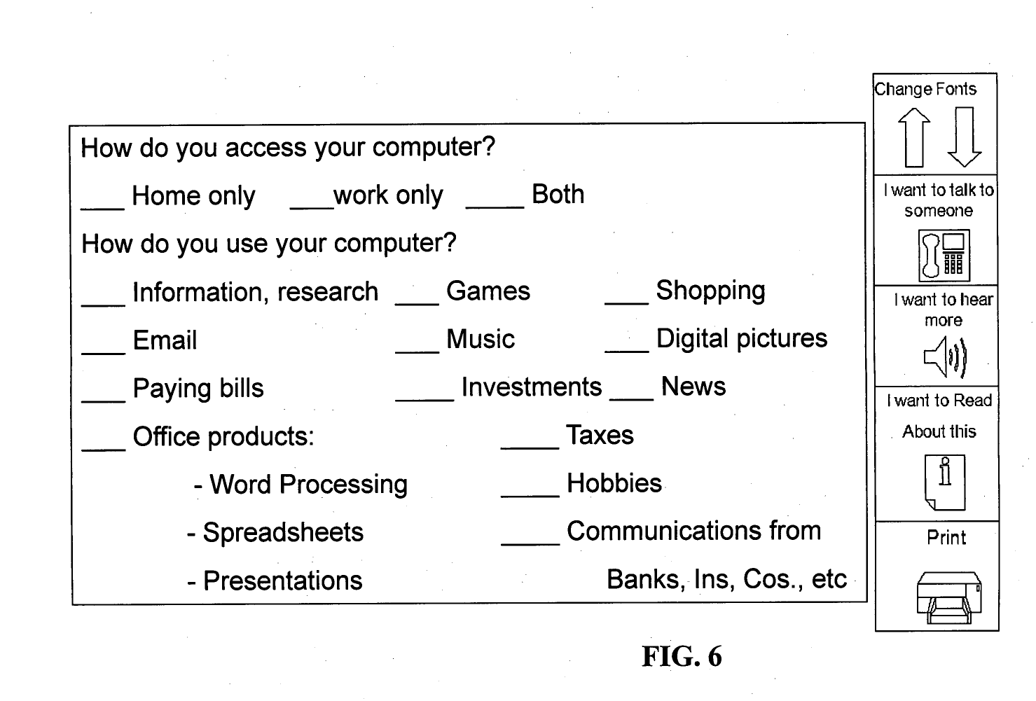

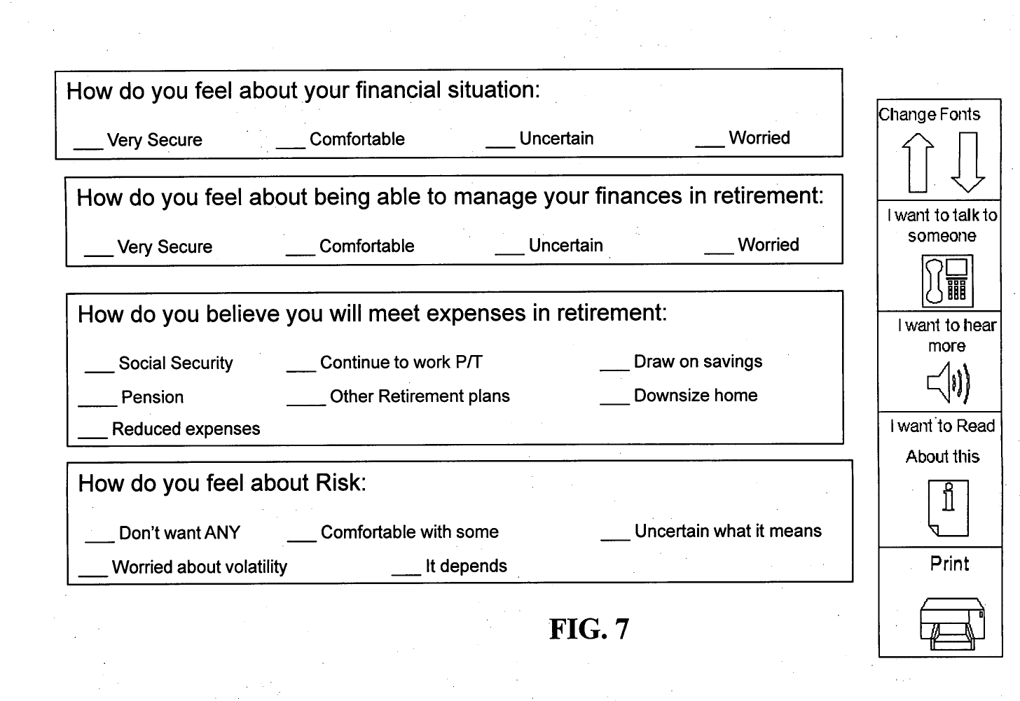

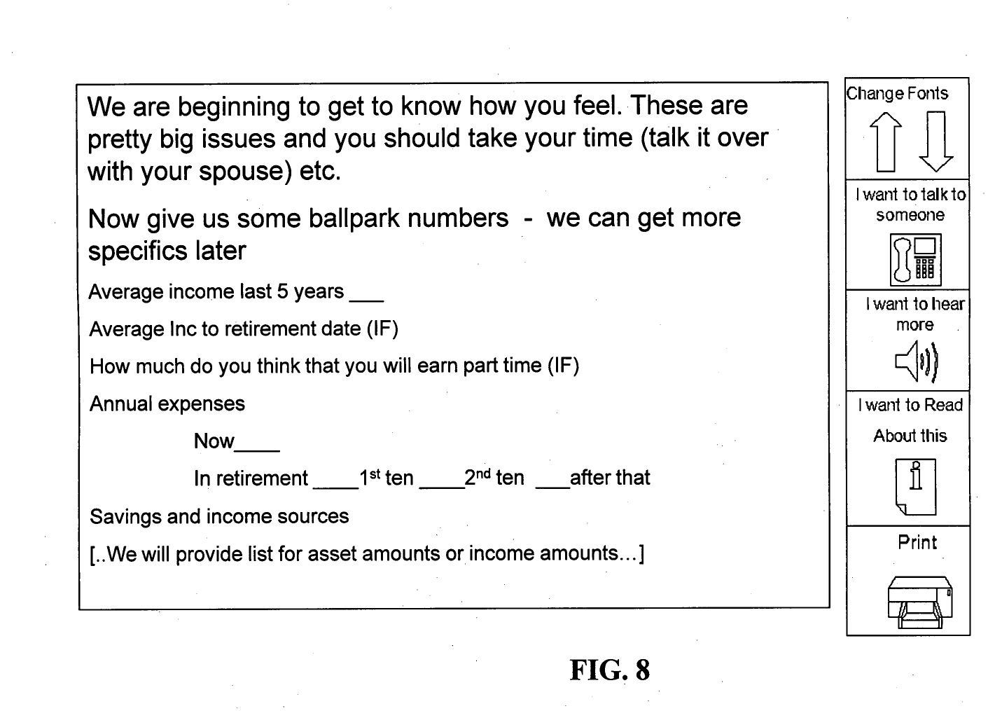

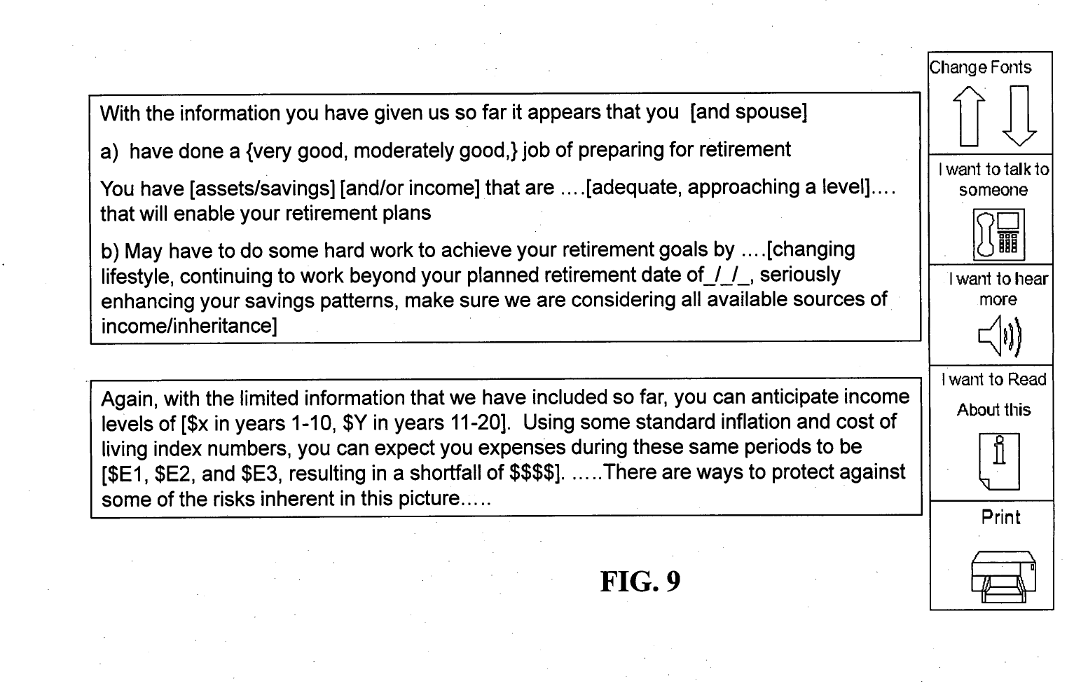

An example of a user interaction with one embodiment of the system of the present invention is provided below, which may to read with reference to FIGS. 1-9 where Retirement Manager Information Collection sample level one user experience; Underlined terms will link to definitions and education content; Bold, underlined, italicized entries represent user inputs; [ ] Brackets indicate computer commands and operations not visible to user; { } Brackets indicate variable information calculated by program or obtained from User Profile; and “>” symbol represents if/then command]:

The description above illustrates one user and potential scenarios based on the answers provided by this user. Other users may provide drastically different information and the system of the present invention may use other question scenarios depending on the User Profile and heuristic methods/strategies employed. It is further possible for a financial planner to modify certain parameters of the system to accommodate the personal style of the user or of the financial planner. Thus, the system of the present invention may be used with financial planning models or scenarios which have not even been contemplated at the present time.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of creating a user customized retirement plan, comprising the steps of:
providing a digital computer system and a plurality of computer workstations linked to the computer system through the Internet;
the computer system transmitting to the user workstation over the Internet a plurality of questions relating to the user, including a plurality of questions relating to quantitative information of the retirement funds of the user and a plurality of questions relating to qualitative information about the user;
the computer system correlating user quantitative information on the retirement funds and user qualitative information to generate a customized retirement plan for the user, the computer system using a plurality of parameters based on the quantitative information to calculate retirement scenarios and through an advice rules engine modifying said parameters based on applying one or more rules with the quantitative information;
the computer system transmitting to the user a plurality of qualitative lifestyle questions relating to the user's lifestyle, said lifestyle questions including questions eliciting a plurality of the following:
the geographic location in which the user desires to retire,
the identity of factors determining the geographical locations in which the user desires to retire,
the relative size of the dwelling in which the user desires to live in retirement, and
the identification of hobbies/interests important to the user in retirement;
the computer system providing the customized retirement plan consistent with user responses to said lifestyle questions;
said questions transmitted to the user workstation over the Internet and displayed on a display of the workstation;
the user answers inputted into the workstation by means of an input device and transmitted to the computer system over the Internet;
the system including an information collection module connected to a reflexive questioning module and an education module that customizes questions to the user;
the system populating a user profile database in the system based on user information collected by the information collection module in conjunction with the reflexive questioning and education modules;
the system including a lifestyle database that includes economic, geographic & demographic and community databases;
the advice rules engine together with the lifestyle database proposing to the user alternative living arrangements to lower cost housing and/or lower cost communities within the user's desired geographical location for retirement if there is a shortfall between projected expenses and projected income in retirement;
the system further including an order entry module, the order entry module performing the step of accessing the economic, geographic & demographic and community databases to link the user to information, shopping or participation sites to support one or more of travel, hobby, education and healthcare websites and filtering the selection of those sites to meet the confines of the retirement plan.

2. The method of claim 1, wherein the lifestyle questions include all of the following:
the geographic location in which the user desires to retire,
the identity of factors determining the geographical location in which the user desires to retire,
the relative size of the dwelling in which the user desires to live in retirement, and
the identification of hobbies/interests important to the user in retirement.

3. The system of claim 1, wherein the advice module provides HTML links or addresses to Internet sites in response to user responses to said lifestyle questions.

4. The method of claim 1, wherein the computer system includes a solutions module that measures the emotional and financial readiness of the user for retirement and if the analysis indicates a need to work part time, directs the user to a referrals database containing names and descriptions of employers that have indicated an interest in, and have an affinity for, hiring part time senior workers;
the solutions module then matches the user with opportunities based on needs and user profile data;
after an initial screening, the system then links the user with potential employer sites.

5. The method of claim 4, wherein the lifestyle questions include all of the following:
the geographic location in which the user desires to retire,
the identity of factors determining the geographical location in which the user desires to retire,
the relative size of the dwelling in which the user desires to live in retirement, and
the identification of hobbies/interests important to the user in retirement.

6. The system of claim 5, wherein the advice module provides HTML links or addresses to Internet sites in response to user responses to said lifestyle questions.

7. The system of claim 4, wherein the advice module provides HTML links or addresses to Internet sites in response to user responses to said lifestyle questions.

8. The method of claim 1, wherein the advice module complies all information accumulated and indexed and correlates and uses internal rules programmed into tables and other procedures contained in the advice engine and provides suggested solutions and courses of action for the user's review;
the system uses the user profile and the lifestyle database to propose changes in spending levels and to identify sources of income not currently monetized, including home equity;
the system further accesses database files which guide the user based on the user profile and provides live links via the Internet to commercial real estate sites with actual listings and market data in the user's desired geographical location.

9. The method of claim 4, wherein the advice module complies all information accumulated and indexed and correlates and uses internal rules programmed into tables and other procedures contained in the advice engine and provides suggested solutions and courses of action for the user's review;
the system uses the user profile and the lifestyle database to propose changes in spending levels and to identify sources of income not currently monetized, including home equity;
the system further accesses database files which guide the user based on the user profile and provides live links via the Internet to commercial real estate sites with actual listings and market data in the user's desired geographical location.
